(19) United States
(12) Patent Application Publication
(10) Pub. No.: US 2010/0009847 A1
(43) Pub. Date: Jan. 14, 2010

(54) Thermal color change wall

(76) Inventor: Chen-Fu Chang, Sanhsia Town (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/216,838

(22) Filed: Jul. 11, 2008

(51) Int. Cl. B41M 5/26

(52) U.S. Cl. 503/226

(57) ABSTRACT

A thermal color change wall having a thermal color change coating covered on the surface thereof that changes color due to a change in temperature.

### BACKGROUND OF THE INVENTION

1. Field of the Invention

The present invention relates to building construction and more particularly, to a thermal color change wall that changes color due to a change in temperature.

2. Description of the Related Art

A wall of a building is usually coated with a paint for protection. A paint for a wall of a building can be a fire retardant substance that significantly delays and can prevent onset of fire. However, the paint of a wall of a building does not change color indicative of a change in temperature.

### SUMMARY OF THE INVENTION

The present invention has been accomplished under the circumstances in view. It is the main object of the present invention to provide a wall structure that changes color due to a change in temperature. To achieve this and other objects of the present invention, the thermal color change wall has a thermal color change coating covered on the surface thereof that changes color due to a change in temperature. The thermal color change is prepared of a mixture formed of a phenol group compound, a color former and a solvent.

### BRIEF DESCRIPTION OF THE DRAWINGS

FIG. 1 is a sectional view of a wall constructed in accordance with the present invention.

FIG. 2 is a schematic drawing showing color change of the thermal color change coating of the wall according to the present invention.

### DETAILED DESCRIPTION OF THE PREFERRED EMBODIMENT

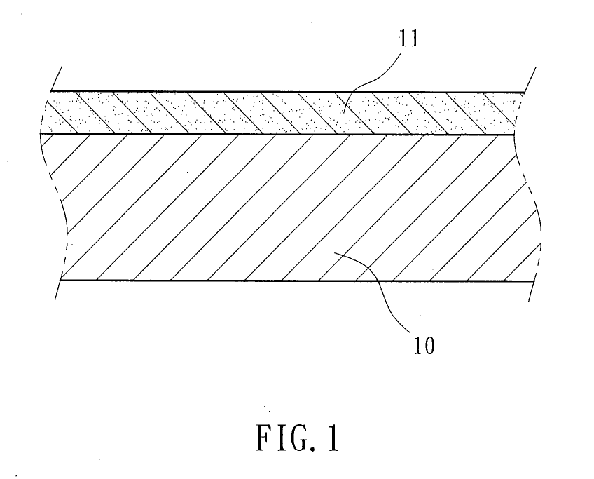

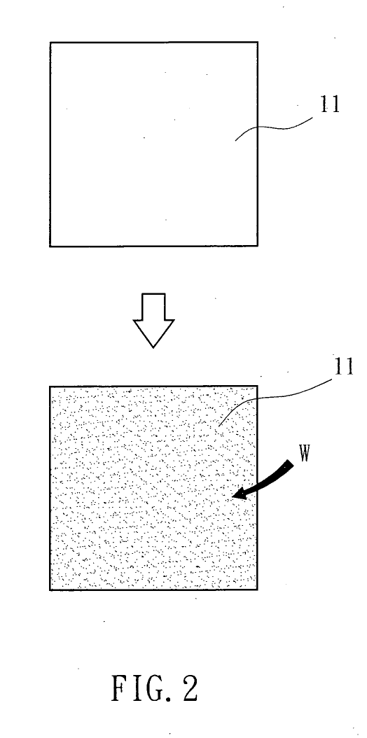

Referring to FIGS. 1 and 2, a wall 10 is shown having a thermal color change coating 11 covered on the surface thereof.

The thermal color change coating 11 is prepared from a mixture formed of a phenol group compound, a color former and a solvent. Dust paint, cement mortar paint and water may be added to the mixture for the thermal color change coating 11.

In an example of the present invention, white paint is added to the mixture for the thermal color change coating 11. When the temperature is within the range of 22° C.-30° C., the thermal color change coating 11 shows white color. When the temperature dropped below 22° C., the thermal color change coating 11 is turned into a light green color. When the temperature passed over 30° C., the thermal color change coating 11 is turned into a pink hue, and the color will become darker when the temperature keeps rising. When a fire occurs, the thermal color change coating 11 will be turned into dark red.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A thermal color change wall having a thermal color change coating covered on a surface thereof, said thermal color change coating being comprised of a mixture formed of a phenol group compound, a color former and a solvent.
